(19) United States
(12) Patent Application Publication
(10) Pub. No.: US 2025/0110018 A1
(43) Pub. Date: Apr. 3, 2025

(54) OPTICAL FIBER TEST EQUIPMENT AND OPTICAL FIBER TEST METHOD

(71) Applicant: NIPPON TELEGRAPH AND TELEPHONE CORPORATION, Tokyo (JP)

(72) Inventors: Atsushi NAKAMURA, Musashino-shi, Tokyo (JP); Yusuke KOSHIKIYA, Musashino-shi, Tokyo (JP)

(73) Assignee: NIPPON TELEGRAPH AND TELEPHONE CORPORATION, Tokyo (JP)

(21) Appl. No.: 18/833,299

(22) PCT Filed: Feb. 14, 2022
(86) PCT No.: PCT/JP2022/005628

§ 371 Date: Jul. 25, 2024

(51) Int. Cl. G01M 11/00

(52) U.S. Cl. CPC G01M 11/3109

(57) ABSTRACT

An object of the present invention is to provide an optical fiber testing apparatus and an optical fiber testing method capable of measuring distance dependency of inter-core crosstalk of a non-coupled multicore fiber at the time of the bidirectional transmission.

An optical fiber testing apparatus (301) according to the present invention includes a measurement device (10) which inputs an optical pulse from one end (A) of a non-coupled multicore fiber (50) to one core of the non-coupled multicore fiber (50), and measures a first light intensity of backscattered light output from the one core at one end (A), and inputs a light pulse from one end (A) of the non-coupled multi-core fiber (50) to another core, and measures a second light intensity of the backscattered light output from the one core at one end (A); and a calculator (20) which calculates, from the first light intensity and the second light intensity, inter-core crosstalk distance dependency when bidirectional transmission is performed.

### TECHNICAL FIELD

The present disclosure relates to an optical fiber testing apparatus and an optical fiber testing method for measuring crosstalk of a non-coupled multicore fiber.

### BACKGROUND ART

A non-coupled multi-core fiber is one promising optical fiber as a medium for achieving future large-capacity optical communication. Inter-core I crosstalk of cores is an important parameter that limits transmission capacity. Therefore, in order to secure a desired transmission capacity, a method for evaluating the magnitude of inter-core crosstalk and the distribution in a longitudinal direction of a non-coupled multicore fiber is required.

NPL 1 and NPL 2 disclose methods for measuring the distribution of inter-core crosstalk in a longitudinal direction when signal transmission directions of respective cores in a non-coupled multicore fiber are the same (unidirectional transmission). NPL 3 proposes a method (bidirectional transmission) in which signal transmission directions of adjacent cores are staggered to each other to reduce the influence of inter-core crosstalk. Also disclosed is a method for measuring inter-core crosstalk in the case of performing such bidirectional transmission.

### CITATION LIST

### Non Patent Literature

[NPL 1] M. Nakazawa et al., “Nondestructive measurement of mode couplings along a multi-core fiber using a synchronous multi-channel OTDR, “Optics Express, vol. 20, No. 11, pp. 12530-12540, 2012.
[NPL 2] M. Ohashi et al., “Simple backscattered power technique for measuring crosstalk of multi-core fibers,” in Proc. 17th Opto-Electronics and Communications Conference, P1_25, 2012.
[NPL 3] A. Sano et al., “Crosstalk-managed high capacity long haul multicore fiber transmission with propagation-direction “interleaving,” J. Lightwave Technol., 32 (16), 2771-2779, 2014.

### SUMMARY OF INVENTION

### Technical Problem

However, NPL 1 and NPL 2 do not disclose a method for measuring inter-core crosstalk when non-coupled multicore fibers are operated by bidirectional transmission. Further, NPL 3 discloses obtaining inter-core crosstalk of the entire non-coupled multicore fiber to be measured at the time of a bidirectional transmission operation, and does not disclose a method for obtaining the distribution (distance dependence) of inter-core crosstalk in the longitudinal direction. That is, there is a problem of difficulty in measuring the distance dependency of inter-core crosstalk when bidirectional transmission is performed by a non-coupled multicore fiber at present.

Therefore, in order to solve the aforementioned problem, an object of the present invention is to provide an optical fiber testing apparatus and an optical fiber testing method capable of measuring the distance dependency of inter-core crosstalk of a non-coupled multi-core fiber at the time of the bidirectional transmission.

### Solution to Problem

In order to achieve the above object, an optical fiber testing apparatus according to the present invention measures the intensity of backscattered light using test light pulses injected into a core at one end of a non-coupled multicore fiber, and calculates the distance dependency of inter-core crosstalk from the intensity of the light.

Specifically, an optical fiber testing apparatus according to the present invention includes a measurement device which inputs an optical pulse from one end of a non-coupled multicore fiber to one core of the non-coupled multicore fiber, and measures a first light intensity of backscattered light output from the one core at the one end, and
inputs a light pulse from the one end of the non-coupled multi-core fiber to one of two cores including the one core of the non-coupled multicore fiber, and measures a second light intensity of the backscattered light output from the other of the two cores at the one end; and
a calculator which calculates, from the first light intensity and the second light intensity, inter-core crosstalk distance dependency between the two cores when bidirectional transmission is performed between the two cores of the non-coupled multi-core fiber in which transmission directions of light are different.

In addition, an optical fiber testing method according to the present invention includes
inputting an optical pulse from one end of a non-coupled multicore fiber to one core of the non-coupled multicore fiber, and measuring a first light intensity of backscattered light output from the one core at the one end;
inputting the light pulse from the one end of the non-coupled multi-core fiber to one of two cores including the one core, and measuring a second light intensity of the backscattered light output from the other of the two cores at the one end; and
calculating, from the first light intensity and the second light intensity, inter-core crosstalk distance dependency between the two cores when bidirectional transmission is performed between the two cores of the non-coupled multi-core fiber in which transmission directions of light are different.

As a first method for calculating distance dependency of inter-core crosstalk,
a light intensity of the optical pulse having passed through the one core of the non-coupled multicore fiber is calculated as a signal light intensity from the first light intensity, a product of a Rayleigh scattering coefficient, a backscattered light capture rate, and an integral value of the second light intensity integrated in a distance direction of a longitudinal direction of the non-coupled multicore fiber is defined as a leakage light intensity, and
a ratio of the signal light intensity to the leakage light intensity is defined as the inter-core crosstalk distance dependency.

As a second method for calculating distance dependency of inter-core crosstalk,
crosstalk between the two cores of the non-coupled multicore fiber when performing unidirectional transmission in which the transmission direction of light is the same between the two cores is calculated from the first light intensity and the second light intensity,
a power coupling coefficient is calculated from the crosstalk, a loss coefficient is calculated from the light intensity of the optical pulse incident from the one end of the non-coupled multicore fiber to the one core and the first light intensity, and
the inter-core crosstalk distance dependency is calculated by substituting the Rayleigh scattering coefficient, the backscattered light capture rate, and the loss coefficient into a power coupling equation of Math. C1.

$$\begin{matrix}[ Math . C1 ] & \\ X {T}_{b} ≅ \frac{{α}_{s}}{α} B h [ \frac{sinh [ ( α L )}{α} \to L exp ( - α L ) ] & ( C1 )\end{matrix}$$

Here, α is the loss coefficient, αₛ is the Rayleigh scattering coefficient, B is the backscattered light capture rate, h is the power coupling coefficient, and L is the fiber length of the non-coupled multicore fiber.

As described above, the present invention can provide an optical fiber testing apparatus and an optical fiber testing method capable of measuring the distance dependency of inter-core crosstalk of a non-coupled multicore fiber at the time of the bidirectional transmission.

Each of the above inventions can be combined as much as possible.

### Advantageous Effects of Invention

The present invention can provide an optical fiber testing apparatus and an optical fiber testing method capable of measuring distance dependency of inter-core crosstalk of a non-coupled multicore fiber at the time of the bidirectional transmission.

### BRIEF DESCRIPTION OF DRAWINGS

FIG. 1 is a diagram for describing an optical fiber testing apparatus according to the present invention.

FIG. 2 is a diagram showing an optical fiber testing method according to the present invention.

FIG. 3 is a diagram showing the waveform of backscattered light obtained by the optical fiber testing apparatus according to the present invention.

FIG. 4 is a diagram showing a method for calculating a loss value from the waveform of backscattered light obtained by the optical fiber testing apparatus according to the present invention.

FIG. 5 is a diagram showing a method for calculating a cumulative value of backscattered light from the waveform of backscattered light obtained by the optical fiber testing apparatus according to the present invention.

FIG. 6 is a diagram showing an example of the optical fiber testing apparatus according to the present invention.

FIG. 7 is a diagram showing the effects of the optical fiber testing apparatus according to the present invention.

FIG. 8 is a diagram showing a method for obtaining Rayleigh scattering coefficients and capture rates.

FIG. 9 is a diagram showing the measurement principle of the optical fiber testing apparatus according to the present invention.

FIG. 10 is a diagram showing the measurement principle of the optical fiber testing apparatus according to the present invention.

### DESCRIPTION OF EMBODIMENTS

Embodiments of the present invention will be described with reference to the accompanying drawings. The embodiments described below are examples of the present invention, and the present invention is not limited to the following embodiments. Note that, in the present specification and the drawings, components having the same reference numerals indicate the same components.

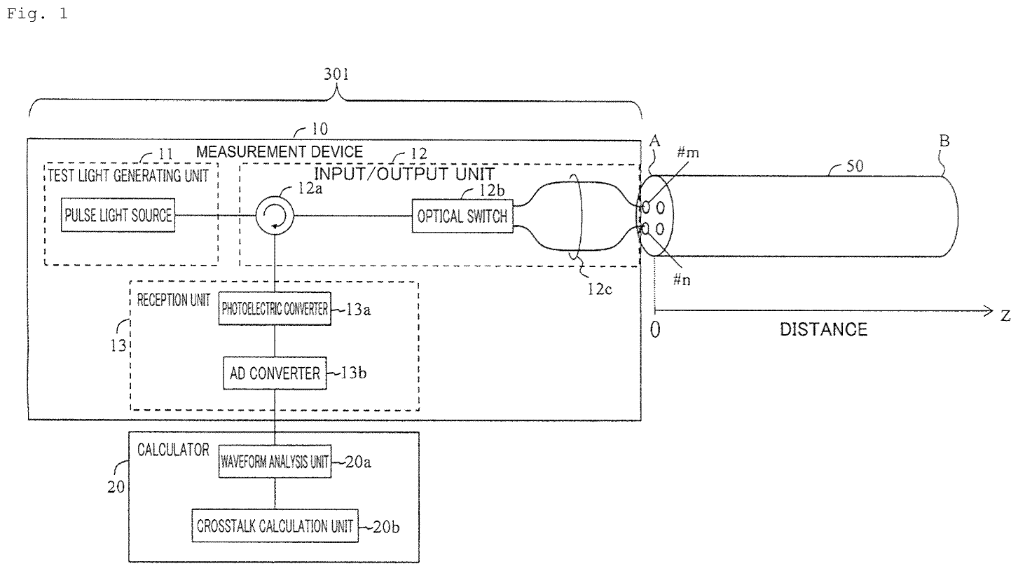

FIG. 1 is a diagram for describing an optical fiber testing apparatus 301 according to the present invention. The optical fiber testing apparatus 301 measures crosstalk at the time of bidirectional transmission using a non-coupled multicore fiber 50 as an optical fiber to be tested. The optical fiber testing apparatus 301 includes
a measurement device 10 which inputs an optical pulse from one end A of the non-coupled multicore fiber 50 to one core (e.g., #m) of the non-coupled multicore fiber 50, and measures a first light intensity of backscattered light output from the one core at the one end A (first measurement), and
inputs a light pulse from the one end A of the non-coupled multi-core fiber 50 to one of two cores (e.g., #m or #n) including the one core of the non-coupled multicore fiber 50, and measures a second light intensity of the backscattered light output from the other of the two cores at the one end A (core #n on the presupposition that the core where the optical pulse is input is #m, or core #m on the presupposition that the core where the optical pulse is input is #n) (second measurement); and
a calculator 20 which calculates, from the first light intensity and the second light intensity, inter-core crosstalk distance dependency between the two cores when bidirectional transmission is performed between the two cores of the non-coupled multi-core fiber 50 in which the transmission directions of light are different.

In the case of a multi-core optical fiber having three or more cores, the above-mentioned “two cores” means adjacent cores.

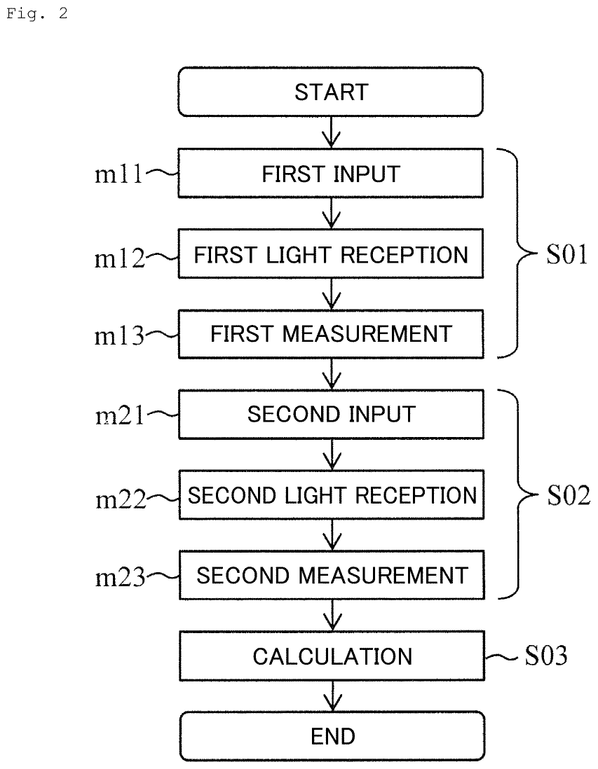

FIG. 2 is a flowchart showing an optical fiber testing method performed by the optical fiber testing apparatus 301. This method includes
inputting an optical pulse from one end A of a non-coupled multicore fiber 50 to one core of the non-coupled multicore fiber 50, and measuring a first light intensity of backscattered light output from the one core at the one end A (step S01);
inputting a light pulse from the one end A of the non-coupled multi-core fiber 50 to one of the two cores including the one core, and measuring a second light intensity of the backscattered light output from the other of the two cores at one end A (step S02); and
calculating, from the first light intensity and the second light intensity, inter-core crosstalk distance dependency between the two cores when bidirectional transmission is performed between the two cores of the non-coupled multi-core fiber 50 in which the transmission directions of light are different (step S03).

The measurement device 10 includes a test light generating unit 11 that generates an optical pulse, an input/output unit 12 that inputs the optical pulse to a non-coupled multicore fiber 50 and captures backscattered light from the non-coupled multicore fiber 50, and a reception unit 13 that measures the intensity of the backscattered light. The measurement device 10 performs step S01 and step S02. The test light generating unit 11 and the input/output unit 12 perform processes m11, m12, m21 and m22, and the reception unit 13 performs processes m13 and m23.

The input/output unit 12 has, for example, an optical circulator 12a, an optical switch 12b, and an input/output device 12c. The optical switch 12b selects the core (#m or #n) of the non-coupled multicore fiber 50 into which the optical pulse is injected, and selects the core (#m or #n) of the non-coupled multicore fiber 50 from which the backscattered light desired to be captured is emitted.

The reception unit 13 has, for example, a photoelectric converter 13a for receiving the backscattered light and converting it into an electric signal, and an AD converter 13b for converting the electric signal from analogue into digital.

The calculator 20 performs step S03. The calculator 20 has, for example, a waveform analysis unit 20a for analyzing the waveform of the electric signal converted into a digital signal, and a crosstalk calculation unit 20b for calculating crosstalk.

The contents of the operation performed by the calculator 20 will be described in the following embodiments.

### Example 1

This example is a method for calculating inter-core crosstalk of a non-coupled multicore fiber at the time of the bidirectional transmission by utilizing integration of backscattered light.

Step S01: The measurement device 10 makes an optical pulse incident on the core #m from one end A of the non-coupled multicore fiber 50, and measures the light intensity of the backscattered light 1 from the core #m at the one end A. The backscattered light 1 is the light intensity of the backscattered light from the incident core.

Step S02: The measurement device 10 makes an optical pulse incident on the core #n from one end A of the non-coupled multicore fiber 50, and measures the light intensity of the backscattered light 2 from the core #m at the one end A. The backscattered light 2 is the light intensity of the backscattered light from the adjacent core. When it is considered that the loss coefficients of each core of the non-coupled multicore fiber 50 are equal to each other, the backscattered light from the core #n by the optical pulse incident on the core #m may be used as the backscattered light 2.

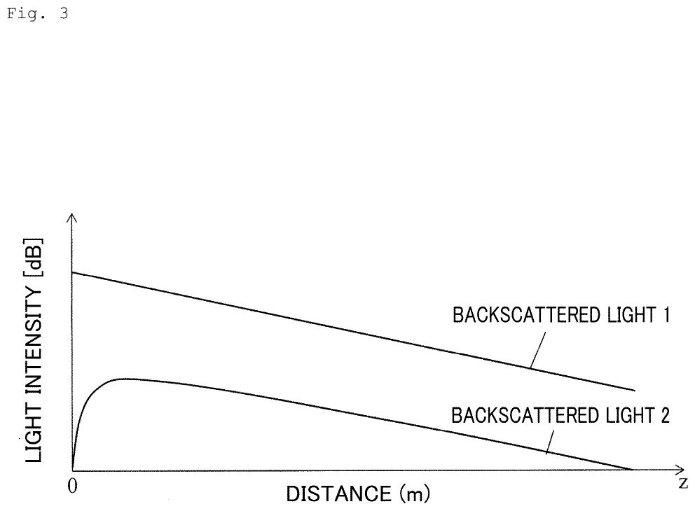

The measurement device 10 can obtain a light intensity distribution as shown in FIG. 3 by performing steps S01 and S02.

### The Calculator 20

calculates a light intensity of an optical pulse having passed through the one core of the non-coupled multicore fiber 50 as a signal light intensity P_{signal} from the first light intensity (backscattered light 1),
defines a product of a Rayleigh scattering coefficient, a backscattered light capture rate, and an integrated value obtained by integrating the second light intensity (backscattered light 2) by a distance in the longitudinal direction of the non-coupled multicore fiber 50, as leakage light intensity P_{bs}, and
defines a ratio of the signal light intensity P_{signal} to the leakage light intensity P_{bs} as the inter-core crosstalk distance dependency.

Step S03: The calculator 20 performs the following calculation using the light intensity distribution shown in FIG. 3.

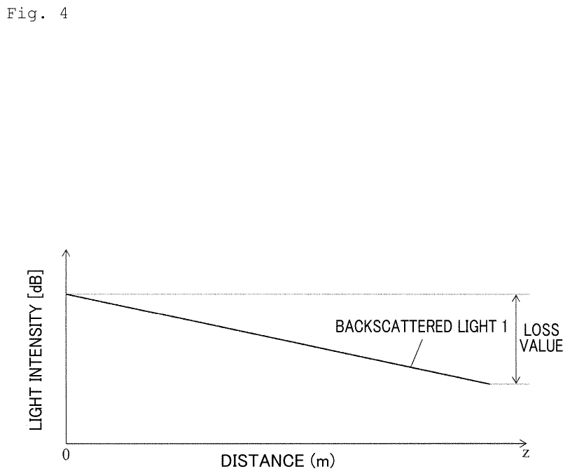

Step m31: As shown in FIG. 4, the calculator 20 calculates the loss value of the core #m over the entire length of the non-coupled multicore fiber 50 from the backscattered light 1. Since the power coupling coefficient, the fiber length and the product of the non-coupled multicore fiber are usually sufficiently smaller than 1, the difference in strength between a near end and a far end can be regarded as a loss value.

Step m32: The signal light intensity P_{signal} of the optical pulse output from the core #m at the other end B is calculated from the loss value of the core #m calculated above. The definition of inter-core crosstalk of the non-coupled multicore fiber at the time of the bidirectional transmission is as described in the appendix 2. In this case, it is necessary to measure the light intensity of the optical pulse at the core #m at the one end A by making the optical pulse incident on the core #m at the other end B. However, the signal light intensity P_{signal} has the same value, whether the optical pulse is an optical pulse injected thereinto at one end A and emitted therefrom at the other end B or an optical pulse injected thereinto at the other end B and emitted therefrom at the one end A (in the opposite direction). Therefore, in this calculation, using this idea, the signal light intensity P_{signal} is acquired for the optical pulse which is made incident on the core #m at one end A and emitted from the core #m at the other end B.

Step m33: The product of the Rayleigh scattering coefficient as and the backscattered light capture rate B of the non-coupled multicore fiber 50 is obtained by any method described in the appendix 1.

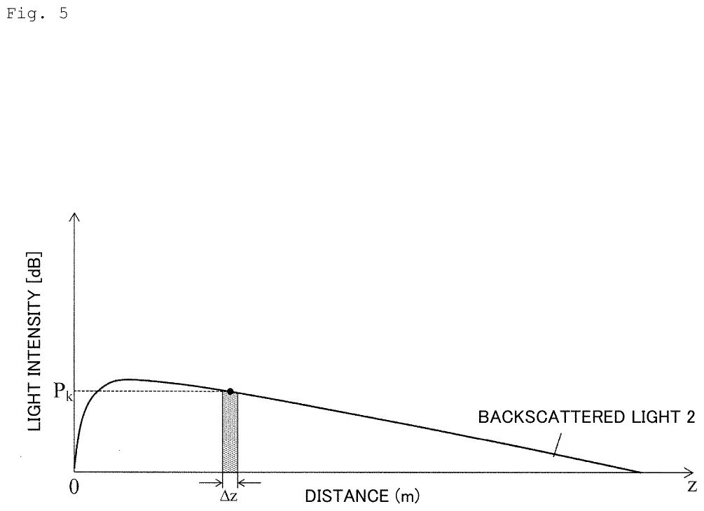

Step m34: As shown in FIG. 5, a cumulative value (leakage light intensity) P_{bs} of the backscattered light 2 is calculated by integrating the light intensity of the backscattered light 2 in the direction of a distance z.

$$\begin{matrix}[ Math . 1 ] & \\ {P}_{bs} = {α}_{s} B {\sum }_{k = 1}^{N} {P}_{k} Δ z & ( 1 )\end{matrix}$$

Here, Pₖ is a light intensity (linear scale) of the k-th backscattered light 2, and Δz is a data interval in the direction of the distance z.

Step m35: An inter-core crosstalk XT_{b} at the time of the bidirectional transmission of the non-coupled multicore fiber 50 is calculated as a cumulative value P_{bs} of backscattered light to signal light intensity P_{signal}.

$$\begin{matrix}[ Math . 2 ] & \\ {XT}_{b} = \frac{{P}_{bs}}{{P}_{signal}} & ( 2 )\end{matrix}$$

The calculator 20 calculates XT_{b} for each distance z to obtain inter-core crosstalk distance dependency when bidirectional transmission is performed.

### Example 2

This example is a method for calculating inter-core crosstalk in bidirectional transmission from inter-core crosstalk at the time of unidirectional transmission of the non-coupled multicore fiber.

Step S01: The measurement device 10 makes an optical pulse incident on the core #m from one end A of the non-coupled multicore fiber 50, and measures the light intensity of the backscattered light 1 from the core #m at the one end A. The backscattered light 1 is the light intensity of the backscattered light from the incident core.

Step S02: The measurement device 10 makes an optical pulse incident on the core #m from one end A of the non-coupled multicore fiber 50, and measures backscattered light 2 from the core #n at the one end A. The backscattered light 2 is the light intensity of the backscattered light from the adjacent core.

The measurement device 10 can obtain a light intensity distribution as shown in FIG. 3 by performing steps S01 and S02.

### The Calculator 20

calculates crosstalk between the two cores of the non-coupled multicore fiber 50 when performing unidirectional transmission in which the transmission direction of light is the same between the two cores from the first light intensity (backscattered light 1) and the second light intensity (backscattered light 2),
calculates a power coupling coefficient h from the crosstalk,
calculates a loss coefficient a from the light intensity of the optical pulse incident from one end A of the non-coupled multicore fiber 50 to one core (e.g., #m) and the first light intensity, and
calculates the inter-core crosstalk distance dependency by substituting the Rayleigh scattering coefficient, the backscattered light capture rate, and the loss coefficient α into a power coupling equation of a Math. C1.

$$\begin{matrix}[ Math . C1 ] & \\ {XT}_{b} ≅ \frac{{α}_{s}}{α} Bh [ \frac{sinh ( α L )}{α} - L exp ( - α L ) ] & ( C1 )\end{matrix}$$

Here, α is the loss coefficient, αₛ is the Rayleigh scattering coefficient, B is the backscattered light capture rate, h is the power coupling coefficient, and L is the fiber length of the non-coupled multicore fiber.

Step S03: The calculator 20 performs the following calculation, using the light intensity distribution of FIG. 3. Step m41: Crosstalk XT between two cores when performing unidirectional transmission can be calculated from the ratio of the backscattered light 1 to the backscattered light 2. The calculator 20 calculates the inter-core crosstalk XT at the time of unidirectional transmission from the light intensity distribution of FIG. 3, and calculates the power coupling coefficient h according to the method described in NPL 2. Step m42: The product of the Rayleigh scattering coefficient and the backscattered light capture rate of the non-coupled multicore fiber 50 is acquired by any method described in the appendix 1. The steps m41 and m42 may be performed first. Step m43: By substituting various parameters obtained in steps m41 and m42 into an equation (C1) representing inter-core crosstalk derived from a power coupling equation, inter-core crosstalk XT_{b} when performing the bidirectional transmission is acquired. A method for deriving the equation (C1) from the power coupling equation will be described in the appendix 2.

The calculator 20 calculates XT_{b} for each distance z to obtain inter-core crosstalk distance dependency when bidirectional transmission is performed.

### EXAMPLES

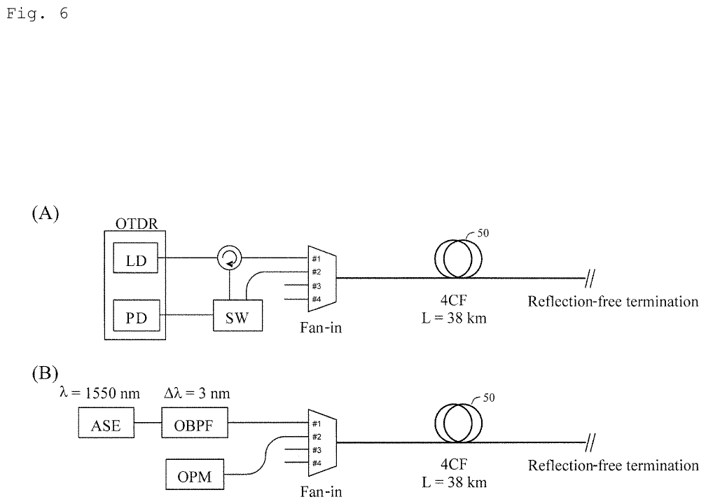

An experiment for confirming whether the opposite transmission crosstalk XT_{b} can be measured by the optical fiber testing apparatus 301 was conducted. The opposite transmission crosstalk XT_{b} was calculated by the methods of Example 1 and Example 2, and compared with the opposite transmission crosstalk XT_{b} obtained by a power meter method. The experimental system is shown in FIG. 6. A configuration shown in FIG. 6 (A) corresponds to the optical fiber testing apparatus 301. FIG. 6 (B) shows a configuration by the power meter method. 4CF (SN: 4CMCF2110-01) manufactured by Furukawa Electric Co., Ltd. was used as the non-coupled multicore fiber 50.

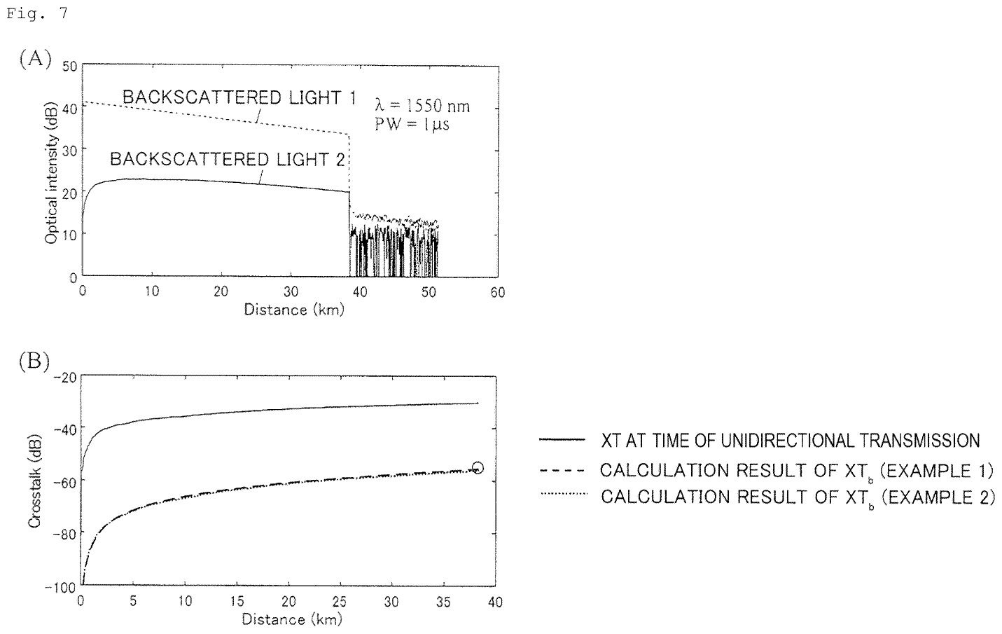

FIG. 7 is a diagram for explaining experiment results. FIG. 7(A) is a diagram for explaining an OTDR waveform measured by the configuration of FIG. 6 (A). The wavelength of the optical pulse is 1,550 nm, and the pulse width is 1 us. A broken line represents the waveform of the backscattered light 1 obtained from the core on which the optical pulse is made incident. A solid line represents the waveform of the backscattered light 2 obtained from the core adjacent to the core on which the optical pulse is made incident.

FIG. 7 (B) is a diagram for explaining the distance dependency of crosstalk calculated from the OTDR waveform. A solid line represents the result of dependency of inter-core crosstalk distance at the time of unidirectional transmission. A broken line represents a result of the inter-core crosstalk distance dependency at the time of the bidirectional transmission, which is directly calculated from the intensity of the backscattered light described in Example 1. A dotted line represents the results of the inter-core crosstalk distance dependency at the time of the bidirectional transmission calculated from the fiber parameters described in Example 2. Both results were almost the same value.

In FIG. 7 (B), a round mark represents a value of crosstalk at the time of bidirectional transmission obtained by the power meter method. The crosstalk XT_{b} at the far end obtained by the calculation methods of Example 1 and Example 2 was substantially the same as the crosstalk obtained by the power meter method. From the above results, it was confirmed that the distance dependency of crosstalk at the time of the bidirectional transmission measured by the optical fiber testing apparatus 301 was reliable.

### [Appendix 1] Method for Acquiring Rayleigh Scattering Coefficient and Capture Rate

### (Method 1)

When a mode field diameter of the core is known, the backscattered light capture rate B is calculated from the mode field diameter by the equation (11).

$$\begin{matrix}[ Math . 11 ] & \\ B = \frac{3}{2} {( \frac{λ}{2 π nw} )}^{2} & ( 11 )\end{matrix}$$

Here, λ is the wavelength (m) of the optical pulse, n is the core refractive index, and w is the mode field radius (m). The loss is tested in a wavelength band (for example, 1,310 nm) in which the Rayleigh scattering loss is dominant, and a Rayleigh scattering coefficient as in a test wavelength band (wavelength of optical pulse) is calculated from the value by equation (12).

$$\begin{matrix}[ Math . 12 ] & \\ {α}_{s} ( {λ}_{1} ) = {( \frac{{λ}_{2}}{{λ}_{1}} )}^{4} α ( {λ}_{2} ) & ( 12 )\end{matrix}$$

Here, λ₁ is a test wavelength, λ₂ is a wavelength in which Rayleigh scattering loss is dominant, and α(λ₂) is a fiber loss value (a value obtained in wavelength λ2 as shown in FIG. 4).

### (Method 2)

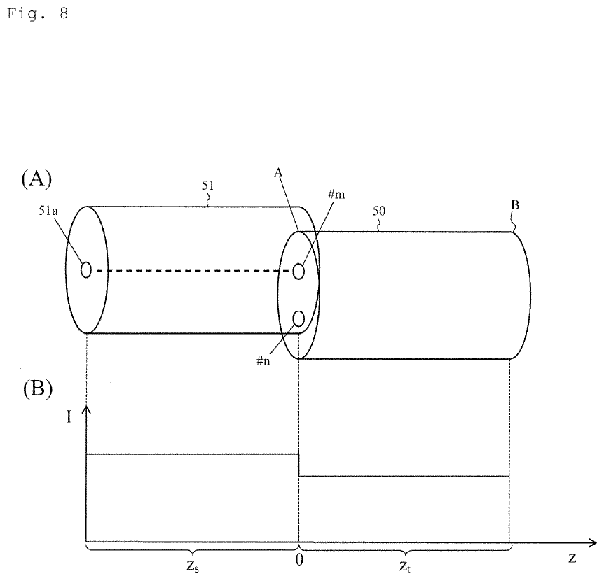

An optical fiber having known Rayleigh scattering coefficient and capture rate is used as a reference fiber, and the Rayleigh scattering coefficient and capture rate of the optical fiber to be tested are acquired by a bidirectional OTDR method (refer to Literature A). FIG. 8 (A) is a diagram showing the present method.

The core 51a of the reference fiber 51 having known Rayleigh scattering coefficient and capture rate and one core (e.g., #m) of the non-coupled multicore fiber 50 are connected. Test light is made incident from the both directions (the reference fiber 51 side and the other end B side) of the test system to measure the OTDR waveform. From the OTDR waveform, a waveform of a structural irregular component I(z) as shown in FIG. 8(B) is obtained. The structural irregular component I(z) can be expressed by the following equation.

$$I ( z ) = 10 log [ \begin{matrix}{α}_{s} ( z ) & B ( z )\end{matrix} ] + {a}_{0} \qquad [ Math . 13 ]$$

Here, a₀ is a constant determined by the input power and the loss.

In the waveform of FIG. 8(B), the structural irregular component I(z) of the reference fiber 51 in the section zₛ is a known value. Therefore, the structural irregular component I(z) of the non-coupled multicore fiber 50 in the section zₜ can be obtained as a relative value of the structural irregular component I(z) of the reference fiber 51. That is, although the Rayleigh scattering coefficient and individual values of the capture rate of the non-coupled multicore fiber 50 are unknown, the product of the Rayleigh scattering coefficient as and the capture rate B can be calculated from the structural irregular component I(z) of the reference fiber 51.
(Literature A) Kazuhide Nakajima et al., “Chromatic Dispersion Distribution Measurement Along a Single-Mode Optical Fiber”, JOURNAL OF LIGHTWAVE TECHNOLOGY, VOL. 15, No. 7, July 1997

### [Appendix 2] Technique for Evaluating Crosstalk of Non-Coupled Multicore Fiber

### (1) Definition of Crosstalk

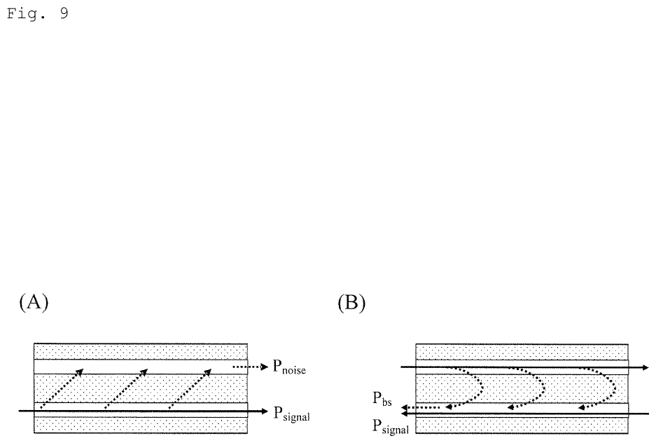

In general, crosstalk is a ratio of the optical power P_{signal} Of a signal intended to be transmitted to the optical power Pₙₒᵢₛₑ of a signal intended to be blocked. The crosstalk XT in the unidirectional transmission is a power ratio (XT=Pₙₒᵢₛₑ/P_{signal}), when the signal light is inject into the core #m at the one end A, of the leakage light output from the adjacent core #n at the other end B to the signal light output from the core #m at the other end B as described above (FIG. 9 (A)). On the other hand, the crosstalk XT_{b} in the bidirectional transmission is a power ratio of a return light P_{bs}, output from the core #m at one end A, of one signal light injected into the adjacent core #n at one end A to a signal light P_{signal}, output from the core #m at the one end A, of another signal light injected into the core #m at the other end B, when the leakage light from the non-adjacent core is sufficiently small (XT_{b}=P_{bs}/P_{signal}), (FIG. 9(B)).
(2) Relationship between Crosstalk And Fiber Parameters Here, the relationship between crosstalk and fiber parameters in a two-core fiber (cores #m and #n) is formulated. The fiber loss in each core is assumed to be equal, and various parameters (fiber loss a, power coupling coefficient h, backscattered light capture rate B, and Rayleigh scattering coefficient αₛ) are assumed to be uniform in the longitudinal direction of the optical fiber. The fiber length is defined as L(m). It is assumed that there is no Fresnel reflection. Under the assumption, the following relationship is established between adjacent cores even in the case of a multi-core fiber having three or more cores.

### i) In Case of Unidirectional Transmission

The light intensity of each core at the position z of the two core fibers can be described by the following power coupling equation.

$$\begin{matrix}[ Math . 21 ] & \\ \frac{{dP}_{m} ( z )}{dz} = - α {P}_{m} ( z ) + h [ {P}_{n} ( z ) - {P}_{m} ( z ) ] & ( 21 )\end{matrix}$$

Here, Pₘ(z) and Pₙ(z) represent light intensities at the core #m and core #n, respectively. Assuming that continuous light of light intensity Pᵢ is made incident only on the core #m from the point of z=0, the solution of equation (21) is as follows.

$$\begin{matrix}[ Math . 22 ] & \\ {P}_{m} ( z ) = \frac{{P}_{i}}{2} exp ( - α z ) [ 1 + exp ( - 2 hz ) ] & ( 22 )\end{matrix}$$

$${P}_{n} ( z ) = \frac{{P}_{i}}{2} exp ( - α z ) [ 1 - exp ( - 2 hz ) ]$$

Therefore, the crosstalk over the entire length of the optical fiber can be expressed by the following equation.

$$\begin{matrix}[ Math . 23 ] & \\ XT = \frac{{P}_{n} ( L )}{{P}_{m} ( L )} = \frac{1 - exp ( - 2 hL )}{1 + exp ( - 2 hL )} = tanh ( hL ) & ( 23 )\end{matrix}$$

From the equation (23), it can be seen that the crosstalk XT at the time of unidirectional transmission is determined by the power coupling coefficient h and the fiber length L. Also, in a desired range (when hL is small), the crosstalk XT increases linearly with respect to the distance L.

### ii) In Case of Opposite Transmission

When continuous light of light intensity Pᵢ is made incident from the core #m at one end A of the optical fiber, the light intensity P_{signal} output from the core #m at the other end B can be described by the following equation.

$$\begin{matrix}[ Math . 24 ] & \\ {P}_{signal} = \frac{{P}_{i}}{2} exp ( - α L ) [ 1 + exp ( - 2 hL ) ] & ( 24 )\end{matrix}$$

On the other hand, when continuous light of light intensity Pⱼ is made incident from the core #n of the other end B of the optical fiber, the light intensity P_{lbs} output from the core #m of the other end B can be expressed by the following equation.

$$\begin{matrix}[ Math . 25 ] & \\ \begin{matrix}{P}_{1 bs} = {\int }_{0}^{L} \frac{{P}_{j}}{2} {α}_{s} B exp ( - 2 α z ) [ 1 - exp ( - 4 hz ) ] dz \\ = \frac{{P}_{j} {α}_{s} B}{4 α ( α + 2 h )} \{ 2 h [ 1 - exp ( - 2 α L ) ] - \\ α exp ( - 2 α L ) [ 1 - exp ( - 4 hL ) ] \}\end{matrix} & ( 25 )\end{matrix}$$

Here, assuming that α>>h and hL<<1, the equation (25) can be approximated as follows.

$$\begin{matrix}[ Math . 26 ] & \\ {P}_{1 bs} ≅ \frac{{α}_{s} B}{2 α} {P}_{j} h [ \frac{1 - exp ( - 2 α L )}{α} - 2 L exp ( - 2 α L ) ] & ( 26 )\end{matrix}$$

Therefore, assuming that Pᵢ=Pⱼ, the crosstalk XT_{b} at the time of the opposite transmission can be expressed by the following equations (24) and (26).

$$\begin{matrix}[ Math . 27 ] & \\ {XT}_{b} = \frac{{P}_{1 bs}}{{P}_{signal}} ≅ \frac{{α}_{s}}{α} Bh [ \frac{sinh ( α L )}{α} - L exp ( - α L ) ] & ( 27 )\end{matrix}$$

From the equation (27), the crosstalk XT_{b} at the time of the opposite transmission is determined by the fiber loss α, the Rayleigh scattering coefficient αₛ, and the backscattered light capture rate B, in addition to the power coupling coefficient h and the fiber length L. In addition, unlike the crosstalk XT at the time of unidirectional transmission, the crosstalk XT_{b} at the time of opposite transmission increases non-linearly with respect to the distance L (exponentially increases when αL is large).

Equation (27) is the aforementioned equation (C1).

### (3) Method for Measuring Opposite Transmission Cross-Talk Using OTDR

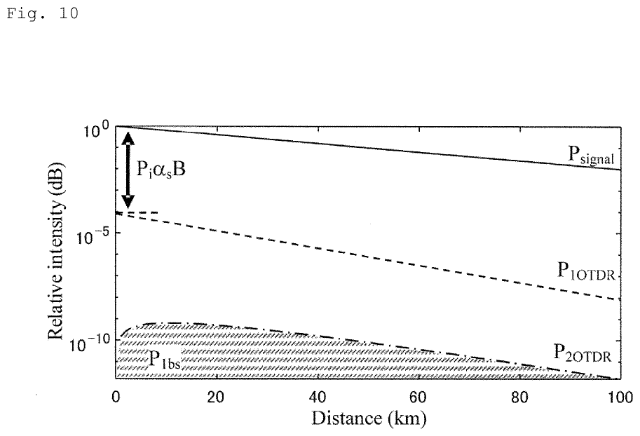

Equation (27) can make it clear that the crosstalk XT_{b} at the time of the opposite transmission can be calculated from “(means a) the cumulative backscattered light intensity P_{lbs} and the transmitted light intensity P_{signal}” or “(means b) the loss coefficient a, the Rayleigh scattering coefficient αₛ, the backscattered light capture rate B and the power coupling coefficient h”. In order to explain the method for realizing the above by the OTDR, an example of calculation of the level diagram of the transmitted light intensity (P_{signal}) and the backscattered light intensity (P_{1OTDR}, P_{2OTDR}) is shown in FIG. 10. In FIG. 10, the solid line represents the transmitted light intensity P_{signal} of the optical pulse in the core #m, the broken line represents the light intensity P_{1OTDR} of the backscattered light from the core #m into which the optical pulse is injected, and the dashed line represents the light intensity P_{2OTDR} of the backscattered light from the adjacent core #n of the core #m into which the optical pulse is injected. The light intensity P_{1OTDR} and the light intensity P_{2OTDR} are values that can be measured by the OTDR. They can be represented by the following equations. Pᵢ is the light intensity of the optical pulse that is made incident on the core #m.

$$\begin{matrix}[ Math . 28 ] & \\ {P}_{signal} = \frac{{P}_{i}}{2} exp ( - α L ) [ 1 + exp ( - 2 hL ) ] & ( 28 )\end{matrix}$$

$${P}_{1 OTDR} = \frac{{P}_{i}}{2} {α}_{s} B exp ( - 2 α L ) [ 1 + exp ( - 4 hL ) ]$$

$${P}_{2 OTDR} = \frac{{P}_{i}}{2} {α}_{s} B exp ( - 2 α L ) [ 1 - exp ( - 4 hL ) ]$$

Means a will be described below. The cumulative backscattered light intensity P_{lbs} can be obtained by integrating the light intensity P_{2OTDR} at a distance z (corresponding to the hatching part of FIG. 10). The transmitted light intensity Pᵢ cannot be obtained directly from the OTDR waveform, but can be calculated from the light intensity P_{1OTDR} and αₛB. The αₛB can be obtained, for example, by the method 1 or the method 2 of the appendix 1 described above.

Means b will be described below. A crosstalk XT at the time of unidirectional transmission is measured, and the loss coefficient α and the power coupling coefficient h are acquired by a method disclosed in NPL 2. Further, αₛB is obtained by the method 1 and the method 2 of the appendix 1 described above, and calculated by substituting it in equation (27).

### REFERENCE SIGNS LIST

10 Measurement device
11 Test light generating unit
12 Input/output unit
12a Optical circulator
12b Optical switch
12c Input/output device
13 Reception unit
13a Photoelectric conversion unit
13b AD converter
20 Calculator
20a Waveform analysis unit
20b Crosstalk calculation unit
50 Optical fiber to be tested (non-coupled multi-core fiber)
51 Reference fiber
301 Optical fiber testing apparatus

1. An optical fiber testing apparatus comprising:
a measurement device which inputs an optical pulse from one end of a non-coupled multicore fiber to one core of the non-coupled multicore fiber, and measures a first light intensity of backscattered light output from the one core at the one end, and
inputs a light pulse from the one end of the non-coupled multi-core fiber to one of two cores including the one core of the non-coupled multicore fiber, and measures a second light intensity of the backscattered light output from the other of the two cores at the one end; and
a calculator which calculates, from the first light intensity and the second light intensity, inter-core crosstalk distance dependency between the two cores when bidirectional transmission is performed between the two cores of the non-coupled multi-core fiber in which transmission directions of light are different.

2. The optical fiber testing apparatus according to claim 1,
wherein the calculator calculates a light intensity of the optical pulse having passed through the one core of the non-coupled multicore fiber as a signal light intensity from the first light intensity,
defines a product of a Rayleigh scattering coefficient, a backscattered light capture rate, and an integrated value obtained by integrating the second light intensity by a distance in the longitudinal direction of the non-coupled multicore fiber as leakage light intensity, and defines a ratio of the signal light intensity to the leakage light intensity as the inter-core crosstalk distance dependency.

3. The optical fiber testing apparatus according to claim 1,
wherein the calculator
calculates crosstalk between the two cores of the non-coupled multicore fiber when performing unidirectional transmission in which the transmission direction of light is the same between the two cores from the first light intensity and the second light intensity,
calculates a power coupling coefficient from the crosstalk,
calculates a loss coefficient from the light intensity of the optical pulse incident from the one end of the non-coupled multicore fiber to the one core and the first light intensity, and
calculates the inter-core crosstalk distance dependency by substituting the Rayleigh scattering coefficient, the backscattered light capture rate, and the loss coefficient into a power coupling equation of Math. C1:
$$\begin{matrix}[ Math . C1 ] & \\ {XT}_{b} ≅ \frac{{α}_{s}}{α} Bh [ \frac{sinh ( α L )}{α} - L exp ( - α L ) ] & ( C1 )\end{matrix}$$
where α is the loss coefficient, αₛ is the Rayleigh scattering coefficient, B is the backscattered light capture rate, h is the power coupling coefficient, and L is the fiber length of the non-coupled multicore fiber.

4. An optical fiber testing method comprising:
inputting an optical pulse from one end of a non-coupled multicore fiber to one core of the non-coupled multicore fiber, and measuring a first light intensity of backscattered light output from the one core at the one end;
inputting the light pulse from the one end of the non-coupled multi-core fiber to one of two cores including the one core, and measuring a second light intensity of the backscattered light output from the other of the two cores at the one end; and
calculating, from the first light intensity and the second light intensity, inter-core crosstalk distance dependency between the two cores when bidirectional transmission is performed between the two cores of the non-coupled multi-core fiber in which transmission directions of light are different.

5. The optical fiber testing method according to claim 4,
wherein, in the calculation of the inter-core crosstalk distance dependency,
the light intensity of the optical pulse having passed through the one core of the non-coupled multicore fiber is calculated as a signal light intensity from the first light intensity, a product of a Rayleigh scattering coefficient, a backscattered light capture rate, and an integral value of the second light intensity integrated in a distance direction of a longitudinal direction of the non-coupled multi-core fiber is defined as leakage light intensity, and
a ratio of the signal light intensity to the leakage light intensity is defined as the inter-core crosstalk distance dependency.

6. The optical fiber testing method according to claim 4,
wherein, in the calculation of the inter-core crosstalk distance dependency,
crosstalk between the two cores of the non-coupled multicore fiber when performing unidirectional transmission in which the transmission direction of light is the same between the two cores is calculated from the first light intensity and the second light intensity,
a power coupling coefficient is calculated from the crosstalk,
a loss coefficient is calculated from a light intensity of the optical pulse incident from the one end of the non-coupled multicore fiber to the one core and the first light intensity, and the inter-core crosstalk distance dependency is calculated by substituting the Rayleigh scattering coefficient, the backscattered light capture rate, and the loss coefficient into a power coupling equation of Math. C1:
$$\begin{matrix}[ Math . C1 ] & \\ {XT}_{b} ≅ \frac{{α}_{s}}{α} Bh [ \frac{sinh ( α L )}{α} - L exp ( - α L ) ] & ( C1 )\end{matrix}$$
where α is the loss coefficient, αₛ is the Rayleigh scattering coefficient, B is the backscattered light capture rate, h is the power coupling coefficient, and L is the fiber length of the non-coupled multicore fiber.
